(19) United States
(12) Patent Application Publication
(10) Pub. No.: US 2018/0250886 A1
(43) Pub. Date: Sep. 6, 2018

(54) SEAM PRODUCTION MACHINE FOR JOINING PLANAR FLEXIBLE COMPONENTS

(71) Applicant: Leister Technologies AG, Kagiswil (CH)

(72) Inventors: Alexander FRANKE, Kerns (CH); Frederike LEHMEIER, Kerns (CH); Adolf NIEDERBERGER, Kägiswil (CH); Urs SCHMID, Buttisholz (CH); Daniel SCHMID, Luzern (CH)

(21) Appl. No.: 15/909,657

(22) Filed: Mar. 1, 2018

(30) Foreign Application Priority Data
Mar. 2, 2017 (EP) 17 158 973.2
Oct. 13, 2017 (EP) 17 196 320.0

(51) Int. Cl. B29C 65/16; A41D 27/24; B29C 65/00

(52) U.S. Cl. CPC B29C 65/1638; A41D 27/245; B29C 66/8145; B29C 66/845; B29C 66/8322

(57) ABSTRACT

A seam production machine for joining at least two planar flexible components is provided, wherein at least one of the components includes thermoplastic synthetic material. Included is a machine housing, which is designed with a work surface and a work arm, wherein a retaining bar mounted movably in the longitudinal axis including a seam production tool and a likewise mounted support bar including a component presser element are provided on the work arm, and a support plate for the components, including at least one oscillatingly drivable component feeder is disposed in the work surface, wherein the component presser element is lowerable and acted upon by a force and, when lowered, cooperates with the at least one component feeder. At least one seam pressing ram, serving as the seam production tool, is disposed at the bottom of the retaining bar, wherein a laser beam is directed at the support plate and forms a laser light spot there for plasticizing the synthetic material of at least one of the components.

### CROSS REFERENCE TO RELATED APPLICATIONS

This application claims priority under 35 USC § 119 to European Patent Application No. 17 158 973.2, filed Mar. 2, 2017, and European Patent Application 17 196 320.0, filed Oct. 13, 2017, the entire disclosures of which are incorporated herein by reference.

### TECHNICAL FIELD

The invention relates to a seam production machine for joining at least two planar flexible components by way of at least one joining seam, wherein at least one of the components comprises thermoplastic synthetic material, which is present in the form of a homogeneous film, or in the form of a textile fabric structure made of mutually intertwined synthetic fibers or synthetic threads, comprising a machine housing, which is designed with a work surface for the components to be joined and a projecting work arm disposed thereabove, at least one retaining bar for receiving a seam production tool and at least one support bar for receiving at least one component presser element that is acted upon by a force and can be lowered onto the work surface, which are accommodated in the work arm so as to protrude downwardly and are movably mounted in the direction of the longitudinal axes thereof, and further comprising a support plate for the components, which is accommodated in the work surface and with respect to which the retaining bar and the support bar are perpendicularly disposed and in which at least one oscillatingly drivable component feeder is inserted, wherein at least the support bar can be lowered onto the support plate under the action of a spring force, and the component presser element when lowered cooperates with the at least one component feeder, wherein at least one seam pressing ram, serving as the seam production tool, is disposed at the bottom of the retaining bar, and a laser beam is directed at the support plate and forms a laser light spot there.

### BACKGROUND ART

Seam production techniques and seam production machines are extremely diverse and well known. Seam production machines of the type described above are used to mechanically produce a joining seam, which may be decorative and/or functional. Such seams may be provided, for example, to join various pieces to one another so as to form an object. The components to be joined can be woven textiles, knitted materials, leather, synthetic materials and the like. To produce the joining seam, usually one or more threads are looped together by sewing, wherein what is known as a needle thread is pushed through the spots to be joined beforehand, using a needle, and forms a thread loop with what is known as a bobbin thread.

Sewing machines for domestic use and for industrial manufacturing all operate according to the same concept. Such sewing machines often comprise a C-shaped frame, at the open end of which the elements necessary for the sewing process are provided, such as a sewing head comprising a needle and a needle thread, a thread tensioner, a presser foot, a bobbin with a hook, and feed mechanisms. A drive motor and force transmission means are provided for driving modern sewing machines, which are usually accommodated in the C-shaped frame.

A sewing machine comprising stitch forming means is known from DE 10 2011 100 103 A1, comprising a needle bar for receiving a needle guiding a needle thread, which is oscillatingly driven parallel to the longitudinal axis thereof, and which can be driven by way of a bar drive device, wherein the sewing machine furthermore comprises at least one workpiece feed means, which can be continuously driven by way of a workpiece feed drive device.

In addition to the natural fibers known in the prior art, synthetic fibers are being increasingly used in the production of apparel. This is not only due to the potentially low costs for synthetic fibers compared to natural fibers, but also due to the high functionality thereof.

A sufficiently well-known problem of joining seams produced from threads is the relative brittleness, dissolvability and/or permeability thereof. The quality of a sewn seam is highly dependent on the care put forth in the sewing person.

### SUMMARY

Proceeding from the above-described prior art, it is the object of the invention to propose a seam production machine by way of which, for example, garments of any kind can be produced in a simple and cost-effective manner, the material of which at least partially comprises synthetic fibers or is even made completely of synthetic fibers or synthetic material. The provided seam production machine according to the invention is to be functionally reliable and easy to operate and have a configuration similar to conventional household or industrial sewing machines.

This object is achieved according to the invention by a seam production machine having features described herein.

A core idea of the invention is to modify a conventional sewing machine, which is designed to join planar flexible components by way of a thread seam, such that weld seams can be produced therewith. Accordingly, in the case of the seam production machine according to the invention for joining at least two planar flexible components by way of at least one joining seam, wherein at least one of the components comprises thermoplastic synthetic material in any arbitrary shape and form, the support plate comprises a translucent work window, which is disposed beneath the seam pressing ram, wherein a laser beam is directed from beneath at the work window of the support plate, or the seam pressing ram is designed to be at least partially translucent, wherein the laser beam is directed at the support plate, from above. The support plate for the components, with respect to which the at least one retaining bar and the at least one support bar/lifting bar are perpendicularly disposed and movable, is disposed in the work surface of the seam production machine. The respective seam production tool can be detachably or fixedly connected to the retaining bar, and the respective component presser element can be detachably or fixedly connected to the support bar. These are preferably exchangeable. The seam production tool and/or the component presser element can be made of metal or another suitable material, such as a glass or synthetic material. The laser beam, which is generated by a laser source, is preferably directed by way of beam-guiding means at the support plate so as to form a laser light spot there. Preferably, an optical light guide is used for this purpose, and preferably a fiber optic light guide. A laser source that emits a laser beam in the near infrared range, preferably having a wavelength of approximately 940 nm, has proven to be particularly advantageous. The laser light can be directed from beneath through a window at the components clamped between the support plate and the component presser foot, or may be directed at these from above. From above, the laser light can act on the components to be joined directly from the side, through the seam pressing ram and/or through the component presser foot. The components to be fused are moved between the work window of the support plate and the seam pressing ram as well as the component presser foot for the formation of the joining seam, which is to say the weld seam, wherein the laser light spot heats and plasticizes the components there. The translucent work window, which is disposed beneath the seam pressing ram, is only absolutely necessary when the laser beam is brought to the weld spot from beneath and directed at the components to be joined so as to form the laser light spot there.

In a preferred embodiment of the invention, the retaining bar is designed as a lifting bar oscillatingly drivable with respect to the longitudinal axis thereof. The component presser element is preferably designed as a component presser foot. The lifting bar, oscillatingly drivable with respect to the longitudinal axis thereof, is received in the projecting work arm, wherein the at least one seam pressing ram is arranged thereon at the bottom, serving as the seam production tool, which replaces the customary sewing needle. When lowered, the at least one lowerable component presser foot that is acted upon by a force, or can be acted upon by a force, which is arranged at the bottom of the support bar, cooperates with the at least one component feeder. The component presser foot is, in particular, mounted so as to be resiliently displaceable at least in a longitudinal direction and, when lowered, is held bearing against the support plate in an axially yielding manner, wherein the force acting upon the component presser foot is provided by a mechanical or pneumatic spring element.

The at least one seam pressing ram of the at least one lifting bar can be lowered onto the support plate by way of the lifting bar and the bar drive device provided therefor, and can be pressed against the support plate by way of a pressing force, wherein the pressing force is preferably settable. The axial length of the seam pressing ram and/or of the lifting bar is preferably selected such that the seam pressing ram is seated on the support plate when the lifting bar is completely lowered. As an alternative, or in addition, the seam pressing ram and/or the lifting bar can be resiliently mounted and guided in the axial direction, so that the thickness of the two components to be joined, which during the production of the joining seam are guided between the seam pressing ram and the support plate so as to locally fuse the components, may be arbitrary.

The seam pressing ram can be produced in one piece from metal or another material having suitable strength and, depending on the material, can be opaque or at least partially opaque. Alternatively, this may also be designed in multiple pieces, for example in the form of a metallic sleeve having a transparent glass core. The laser beam that is directed at the support plate can originate from a laser source that is disposed inside or outside the machine housing of the seam production machine.

In another preferred embodiment of the invention, the retaining bar and the support bar are designed integrally with one another and form a receiving bar for the seam production tool and the component presser element. The component presser element and the seam production tool are preferably likewise designed integrally with one another wherein, in an advantageous embodiment of the invention, the seam pressing ram, serving as a combined component presser element/seam production tool, is advantageously designed as a seam pressing ram, and preferably as a seam pressing roll. In a particularly advantageous embodiment, the seam production machine according to the invention comprises only one receiving bar, at the bottom of which the seam pressing roll is disposed. The combined component presser element/seam production tool is acted upon by a spring force corresponding to the non-combined component presser element, and can be lowered onto the work surface, and in particular the support plate thereof, or the work window of the support plate.

In another preferred embodiment of the seam production machine according to the invention, in which the retaining bar and the support bar are present separately from one another, the seam pressing ram is designed to be at least partially translucent, and the laser beam is directed at the support plate, from above. In a further advantageous embodiment of the invention, the laser beam is directed through the seam pressing ram at the support plate. As an alternative, the laser beam can also be directed through the component presser foot at the support plate, provided the foot plate thereof has a suitable cut-out or a corresponding translucent window, or the foot plate is made entirely of a translucent glass or plastic material.

The at least one seam pressing ram, at the end face, preferably has a shaping pressure profile for the joining seam, which determines the shape, which is to say the geometry of the joining seam. This means that the ram is not flat at the end face, but has projections and/or depressions, which shape the joining seam. For example, dashed or dotted weld seams could be generated in this way. This is also possible, of course, by way of the outer contour of the seam pressing ram and/or by way of the shape of the laser light spot. The seam pressing ram, as has already been described above, is preferably exchangeable so as to generate joining seams that have differing shapes and/or widths by way of welding.

When using a non-translucent seam pressing ram in conjunction with a translucent work window through which the laser beam passes, it has proven to be particularly advantageous, for the protection of the surroundings against dangerous laser radiation, to select the size of the ram such that it completely covers the laser light spot from above.

The component presser foot can include a foot cut-out for the seam pressing ram to pass through, so that this can be supported on the support plate. The foot cut-out and the cross-sectional shape of the seam pressing ram are preferably adapted to one another. Alternatively, the foot may be designed without a foot cut-out, if this instead comprises a transparent window for the laser beam to pass through, and the seam pressing ram is placed onto the component presser foot and presses the same against the support plate, so as to press together the components to be joined after plasticizing. In principle, it is also possible to use the component presser foot alone as the seam pressing ram, wherein this can be lowered in the conventional manner onto the support plate by way of a presser foot actuating device, independently of the lifting bar, so as to clamp the components to be joined and move these forward through the component feeder. The invention also includes the option to attach the component presser foot, instead of the seam pressing ram, at the bottom of the lifting bar so as to be displaceable with respect to the lifting bar when acted upon by a spring force, while applying a basic force on the component presser foot, which is intensified by the downward movement of the lifting bar and reduced during the upward movement of the lifting bar.

In a particularly advantageous embodiment of the invention, the laser beam is directed at the support plate in a pulsed manner. The pulse duration and the output of the laser beam are preferably dependent on an oscillating frequency of the lifting bar or of the component feeder. This means that the welding process can take place while the components to be joined are not being moved by the component feeder. Accordingly, the pressing operation and the preferably simultaneous energy input by way of the laser beam for generating the joining seam are preferably carried out when the component feeder is not operating. On the other hand, however, the welding process can also take place while the components to be joined are being moved by the component feeder. In this case, the pressing operation and the preferably simultaneous energy input by way of the laser beam for generating the joining seam are carried out when the component feeder is operating. In this case, at least the laser beam, and optionally also the support plate, the component presser foot and the seam pressing ram, move along with the oscillating movement of the component feeder. The pulsed laser beam is preferably triggered by the movement of the lifting bar or of the component feeder. For this purpose, appropriate detectors are provided. The use of a pulsed laser beam is, in particular, advantageous in embodiments of a seam production machine according to the invention in which the retaining bar is designed as a lifting bar oscillatingly drivable with respect to the longitudinal axis thereof, and the seam production tool is lifted off the components and subsequently placed back thereon in an oscillating manner.

In an advantageous embodiment of the seam production machine according to the invention, the oscillating frequency of the lifting bar or of the component feeder can be set separately from one another. In this way, the temporal advancement of the components to be joined for producing the joining seam can be influenced, and the weld speed, and in particular the duration of the time allowed for plasticizing and that allowed for compressing, can be influenced. The lifting bar and the component feeder can preferably be driven synchronously. It has proven to be particularly advantageous to allow the advancement of the component feeder during each cycle to be freely selectable for the welding operation. In this way, the distances between the individual weld spots can be easily varied, so that not only a continuous linear weld seam, but also a dotted or dashed weld seam can be generated without difficulty.

In a further particularly advantageous embodiment of the invention, the laser beam is directed at the support plate in a non-pulsed manner. The use of a non-pulsed laser beam is, in particular, advantageous in embodiments of a seam production machine according to the invention in which the retaining bar is not designed as a lifting bar oscillatingly drivable with respect to the longitudinal axis thereof, and the seam production tool acts on the components to be fused without being raised, which is to say presses these continuously against the work surface, and in particular the work window of the work surface. This is the case, for example, when the retaining bar and the support bar are designed integrally with one another as a receiving bar, and the component presser element and the seam production tool are designed integrally as a seam pressing ram, wherein the seam pressing ram preferably comprises a seam pressing roll. The integrally designed seam production tool/component presser element is acted upon by a spring force and can be lowered onto the work surface, and in particular the support plate thereof or the work window of the support plate.

In a preferred variant of the seam production machine according to the invention, the work window and the component feeder are disposed transversely to the movement direction of the component feeder and next to, as well as connected to, one another, and move synchronously with one another.

The seam production machine according to the invention is provided for producing a welded joining seam when joining at least two planar flexible components, of which at least one comprises thermoplastic synthetic material, and more particularly by way of laser radiation and mechanical pressure, wherein one component is highly absorbent with respect to the laser radiation, and the other component is preferably transmitting. Due to heat and pressure, the two components fuse locally, wherein the applied component-feed-method is inspired to a high degree by conventional sewing using a sewing machine. The seam production machine according to the invention is characterized by the combination of a conventional sewing machine, which has the features of the preamble of claim 1, with a laser source and a laser optics head, which projects a homogeneous, or an inhomogeneously illuminated, laser spot having an arbitrary shape at the components to be joined. The laser spot can have a rectangular design, for example, having a surface area of several square millimeters, or may also have a linear design, for example. The laser beam is directed at the components either in non-pulsed or pulsed form, wherein the pulse energy and optionally the pulse length are matched and optimized for the component combination.

This results in a plurality of advantages. It is possible to generate flat, almost invisible and possibly waterproof seams. No potentially toxic additives, adhesives or tapes are needed to join synthetic material-based woven fabrics. The laser seam does not need to cure or dry, but may be immediately subjected to load. Weld seams do not dissolve due to weather or detergents, as seams sealed by way of tapes often do. In addition to inelastic seams, it is also possible to produce elastic seams by way of the seam production machine according to the invention. The joining of the components by way of the seam production machine according to the invention is ergonomically very close to conventional sewing. No major difference is required in terms of the machine geometry, the machine operation, and the component handling. This seam production machine can thus be readily used by existing staff.

In principle, the option also exists to convert existing sewing machines to laser. Machines that can actually be used for this application are readily available since the entire mechanism can be used for producing the joining seam and for component feeding, and differs only insignificantly from the operation of a conventional machine. The needle of a conventional sewing machine is preferably replaced with a seam pressing ram, which presses the at least two component layers together at the laser welding moment. The laser beam can be introduced from beneath, and/or from above, into the at least one laser light-absorbing component.

For example, the laser optics head can be at least partially integrated into the lower component feed device, thus making it possible for the laser light spot, together with the support plate, the component presser foot and the seam pressing ram, to be moved along with the oscillating movement of the component feeder, analogously to conventional sewing machines. However, no beam-conducting parts, such as glass fibers, are moved, so that sensitive components do not experience stress as a result of the continuous movement. The laser beam is freely guided in the air at the interface between fixed and moving parts Due to the special arrangement of the optics, the positions of the laser spot, the support plate, the component presser foot and the seam pressing ram relative to the components to be joined remain stable during the movement of the conveyor. In this embodiment, this advantageously allows welding during movement of the components. The translucent work window is easy to replace should it have become unusable due to soiling or weld penetration. Preferably, welding always takes place when the ram presses the fabric onto the window. The laser pulse is triggered automatically, coupled to the rotational position of the drivable component feeder and the seam pressing ram. The maximum speed of the machine is limited by the output of the laser source and the required pulse duration per weld spot. The advancement of the components to be joined is speed-variable for each sewing machine. In this way, it is possible to place the individual spot welds without gaps, in an overlapping manner or at defined distances. Furthermore, it is possible not to weld with every advancement, but only with every second, third or fourth advancement. The laser pulse is preferably only triggered when the seam pressing ram, with or without components present on the work window, presses on the work window. The translucent work window and the at least one pressing ram are designed to be approximately the same size, wherein the at least one pressing ram is preferably larger than the laser light spot. In this way, no direct laser light can escape. Laser safety and the risk of burns to the hands of the operators are thus considerably improved.

Deviating from this solution comprising the laser optics head in the lower component feed device, it is also possible to direct the laser beam from above at the components and have it penetrate these. Again, the needle would preferably be replaced with the seam pressing ram, serving as the seam production tool, which simultaneously ensures pressing and guides the laser beam. A metal pipe comprising a window at the bottom or a solid glass rod, having any arbitrary cross-section, such as circular, rectangular or hexagonal, into which the laser light is coupled, would be conceivable here. This arrangement would also be close to a conventional sewing machine in terms of operation. The customary above-described advantages apply here accordingly.

The invention enables a specific method for joining at least two planar flexible components by way of at least one joining seam, wherein at least one of the components comprises thermoplastic synthetic material, which is present in the form of a homogeneous film, or in the form of a textile fabric structure made of mutually intertwined synthetic fibers or synthetic threads, by way of a laser welding method, wherein a seam production machine comprising a machine housing is used, which is designed with a work surface for the components to be joined and a projecting work arm disposed thereabove and which comprises a displaceably guided lifting bar received in the work arm for receiving a seam production tool, the lifting bar being oscillatingly driven with respect to the longitudinal axis thereof, a support plate for the components, which is accommodated in the work surface and with respect to which the lifting bar is perpendicularly disposed and in which at least one component feeder is inserted and oscillatingly driven, and is used with at least one lowerable component presser foot that is acted upon by a force and, when lowered, cooperates with the at least one component feeder. At least one seam pressing ram, serving as a seam production tool, is disposed at the bottom of the retaining bar, a laser beam is directed at the support plate, from beneath or from above, and a laser light spot is formed on the support plate or on one of the components resting on the support plate.

### BRIEF DESCRIPTION OF THE DRAWINGS

The invention will be described hereafter in greater detail based on three exemplary embodiments that are illustrated in the drawings. Additional features of the invention will be apparent from the description of the exemplary embodiments in conjunction with the claims. The individual features of the invention can be implemented either alone or as several together in a seam production machine according to the invention. In the drawings:

FIG. 1 shows a first exemplary embodiment of the seam production machine according to the invention, in which the laser beam is directed from beneath at the support plate, wherein the retaining bar for receiving the seam production tool and the support bar for receiving the component presser element are designed separately from one another;

FIG. 2 shows a second exemplary embodiment of the seam production machine according to the invention, in which the laser beam is directed from above at the support plate, wherein the retaining bar for receiving the seam production tool and the support bar for receiving the component presser element are designed separately from one another, and the seam pressing ram is designed to be translucent, and the laser beam is directed through the seam pressing ram at the support plate;

FIG. 3 shows a third exemplary embodiment of the seam production machine according to the invention, in which the laser beam is directed at the support plate, from above, wherein the retaining bar for receiving the seam production tool and the support bar for receiving the component presser element are designed separately from one another, the support bar is connected to the retaining bar, and the component presser foot is designed to be partially translucent and forms the seam pressing ram, wherein the laser beam is directed through the component presser foot at the support plate;

FIG. 4 shows a fourth exemplary embodiment of the seam production machine according to the invention, in which the laser beam is directed at the support plate, from beneath, wherein the retaining bar for receiving the seam production tool is designed integrally with the support bar for receiving the component presser element, and the seam production tool is designed integrally with the component presser element; and

FIG. 5 shows a detailed illustration including a top view onto the support plate according to FIG. 4.

### DETAILED DESCRIPTION

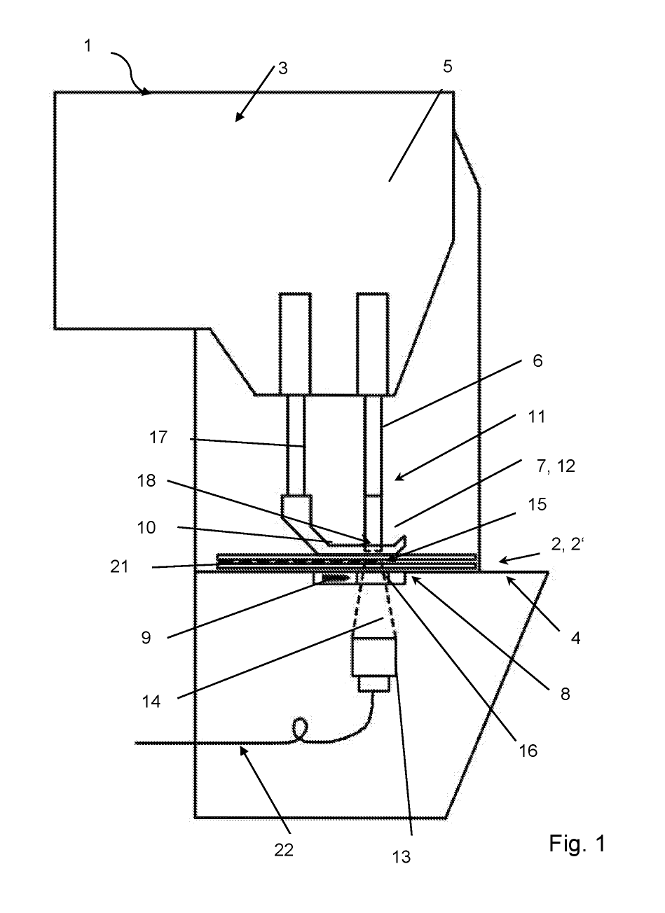

FIGS. 1 to 3 show differently designed seam production machines 1 according to the invention in a schematic illustration, in which the retaining bar 6 for receiving the seam production tool 7 and the support bar 17 for receiving the component presser element 10 are designed separately from one another, and the seam production tool 7 and the component presser element 10 are respectively attached to the corresponding rods 6, 17. A seam pressing ram 12 is provided as the seam production tool 7, and a component presser foot 10 is provided as the component presser element 10. The seam production machine 1 in question is provided for joining at least two planar flexible components 2, 2′ by way of a joining seam 21, and in particular a weld seam, wherein at least one of the components 2, 2′ comprises thermoplastic synthetic material, which is present in the form of a homogeneous film, or in the form of a textile fabric structure made of mutually intertwined synthetic fibers or synthetic threads. The seam production machine 1 comprises a machine housing 3, which is designed with a work surface 4 for the components 2, 2′ to be joined to rest thereon and with a projecting work arm 5 disposed thereabove. A lifting bar 6 that is oscillatingly drivable with respect to the longitudinal axis thereof is disposed in the work arm 5 as a retaining bar 6 for receiving the seam production tool 7 for generating the joining seam 21. The lifting bar 6 is connected to a lifting bar drive device, which is not shown in the figures and which preferably comprises an electric drive motor.

The seam production machines 1 moreover comprise a support plate 8 for the components 2, 2′, which is received in the work surface 4 and, with respect to which the lifting bar 6, is perpendicularly disposed, and in which at least one oscillatingly drivable component feeder 9 is inserted. The component feeder 9 is connected to a component feeder drive device, which is not shown and which preferably comprises an electric drive mechanism. According to FIGS. 1 to 3, the seam production machines 1 additionally comprise a lowerable component presser foot 10 that is acted upon by a force and, when lowered, rests resiliently on the support plate 8 and cooperates with the component feeder 9 so as to advance the two components 2, 2′.

The lifting bar 6 protrudes beyond the work arm 5 with a lower bar end 11, at the bottom of which the seam pressing ram 12, serving as the seam production tool 7, is disposed. A laser optics head 13 is provided on all seam production machines 1, which is connected to a laser source, which is not shown in FIGS. 1 to 3, via a light guide 22. A laser beam 14 is supplied from the laser source to the laser optics head 13, which is directed via the laser optics head 13 at the support plate 8 and forms a laser light spot 15 there.

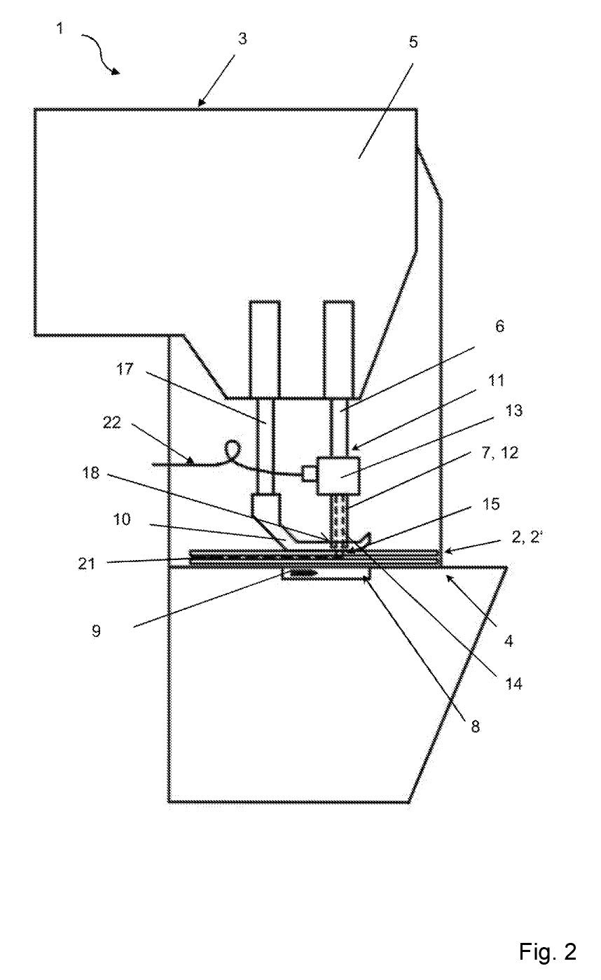

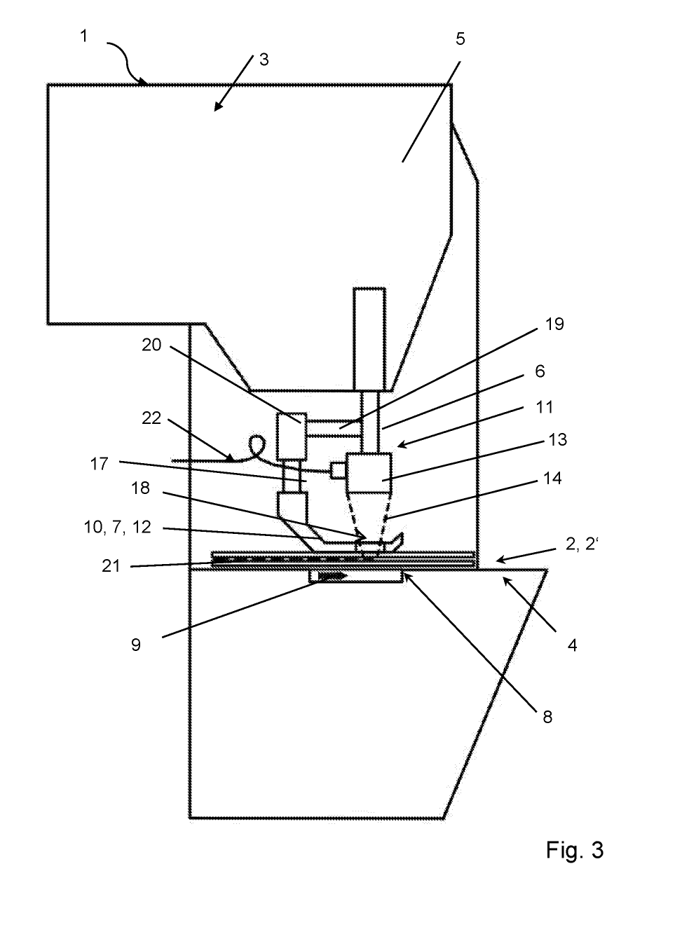

In the exemplary embodiment according to FIG. 1, the laser optics head 13 is disposed in the machine housing 3 beneath the work surface 4 and irradiates the support plate 8 of the work surface 4 from beneath. In the exemplary embodiments according to FIGS. 2 and 3, the laser optics head 13 is disposed at the respective bottom end 11 of the lifting bar 6 and directly or indirectly irradiates the support plate 8 of the work surface 4 from above. The component presser foot 10 is acted upon by a force by way of at least one mechanical or pneumatic spring system disposed in the machine housing 3.

In the exemplary embodiment shown in FIG. 1, the support plate 8 of the work surface 4 comprises a translucent work window 16, which is disposed beneath the seam pressing ram 12, wherein the laser beam 14 is directed from beneath at the work window 16 of the support plate 8. The laser beam penetrates the work window 16 and applies laser light from beneath to the components to be joined. In the working direction of the seam production machine 1, the work window 16 is disposed downstream of the component feeder 9. The component presser foot 10 is attached to a support bar 17 of an actuating device (not shown in FIG. 1) by way of which the component presser foot 10 can be displaced in the vertical direction. The component presser foot 10 and the seam pressing ram 12 are made of metal and thus are impervious to the light of the laser beam 14. The component presser foot 10 has a foot cut-out 18 for the seam pressing ram 12 to pass through, wherein the foot cut-out 18 is adapted to the cross-sectional shape of the seam pressing ram 12.

FIG. 2 illustrates another embodiment of the seam production machine 1 according to the invention, in which the laser optics head 13 is disposed at the bottom bar end 11 of the lifting bar 6. In this case, the seam pressing ram 12 is made of a material transparent to laser light. It is attached at the bottom of the laser optics head 13 in direction of extension of the lifting bar 6. The laser beam 14 is coupled into the laser light-conducting seam pressing ram 12 and guides the laser beam 14 to the support plate 8 of the work surface 4. The component presser foot 10 is made of metal and comprises a foot cut-out 18 for the seam pressing ram 12. The laser optics head 13 is moved up and down oscillatingly together with the lifting bar 6. This is therefore preferably connected via a flexible light guide 22 to the laser source, which is not shown in FIG. 2.

The exemplary embodiment shown in FIG. 3 differs from the exemplary embodiment shown in FIG. 2 only in that the component presser foot 10 forms the seam pressing ram 12. The component presser foot 10 is attached at the bottom end 11 of the lifting bar 6 above the laser optics head 13 by way of a horizontally extending retaining arm 19. The vertical support bar 17 for the component presser foot 10 has a shortened design and is connected to the horizontal retaining arm 19 via an angular intermediate piece 20. As a result, it is not only the laser optics head 13 that is moved up and down oscillatingly together with the lifting bar 6, but also the component presser foot 10. In one variant, the angular intermediate piece 20 rigidly connects the vertical support bar 17 to the horizontal retaining arm 19, and in another variant the angular intermediate piece 20 horizontally displaceably connects the vertical support bar 17 to the horizontal retaining arm 19. In the second case, the angular intermediate piece 20 comprises an energy accumulator on the inside, which is not visible in FIG. 3, which acts upon the vertical support bar 17 of the component presser foot 10 with a downward force, so that the component presser foot 10 is always pressed against the support plate 8, independently of the present lifting position of the lifting bar 6, and is thus held thereon, or the components 2, 2′ placed onto the work surface 4 are always pressed against the support plate 8.

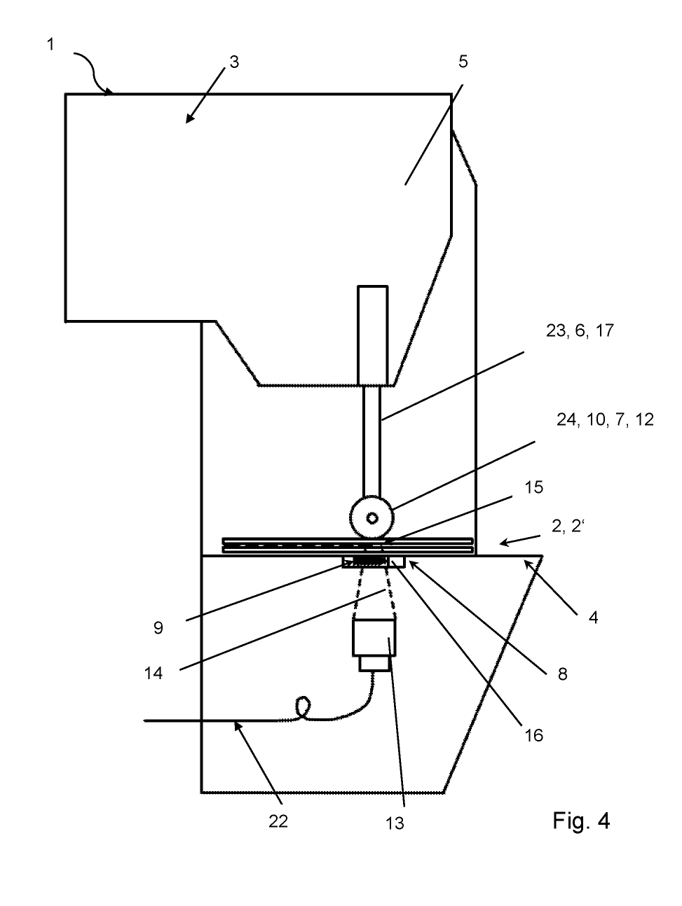

The exemplary embodiment illustrated in FIG. 4 shows a schematic representation of a seam production machine 1 according to the invention in which the laser beam 14 is directed from beneath at the translucent work window 16 of the support plate 8. The laser beam originates from a laser optics head 13 that is received in the machine housing 3 and disposed in the machine housing 3 beneath the work surface 4 comprising the support plate 8 and the work window 16 and irradiates the support plate 8 of the work surface 4 from beneath. The retaining bar 6 for receiving the seam production tool 7 and the support bar 17 for receiving the component presser element 10 as in FIGS. 1 to 2 are designed integrally with one another, which is to say are formed by a single receiving rod 23, wherein the seam production tool 7 and the component presser element 10 as in FIGS. 1 to 3 are likewise further designed as an integral seam pressing ram 12, and in particular as an integral seam pressing roll 24, and attached to the bottom of the receiving bar 23. The work arm 5 comprises an energy accumulator on the inside, which is not visible in FIG. 4, which acts upon the vertical receiving bar 23 of the seam pressing roll 24 with a downward force, so that the seam pressing roll 24, at least when lowered, is always pressed against the support plate 8 or the translucent work window 16 thereof, and is thus held permanently thereon during the welding process, and thereby always presses the components 2, 2′, placed onto the work surface 4, against the support plate 8.

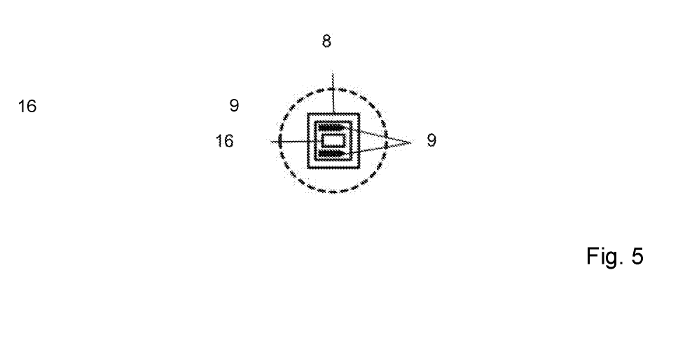

FIG. 5 shows the support plate 8 comprising the work window 16 and the component feeder 9 in detail and illustrates the arrangement thereof. The work window 16 and the component feeder 9 are disposed transversely to the direction of movement of the component feeder 9 and next to, as well as connected, to one another (not shown), and move synchronously with one another.

1. A seam production machine for joining at least two planar flexible components by way of at least one joining seam, at least one of the components comprising thermoplastic synthetic material, which is present in the form of a homogeneous film, or in the form of a textile fabric structure made of mutually intertwined synthetic fibers or synthetic threads, comprising a machine housing, which is designed with a work surface for the components to be joined and a projecting work arm disposed thereabove, at least one retaining bar for receiving a seam production tool and at least one support bar for receiving at least one component presser element that is acted upon by a force and can be lowered onto the work surface, which are received in the work arm so as to protrude downwardly and are movably mounted in the direction of the longitudinal axes thereof, and further comprising a support plate for the components, which is received in the work surface and with respect to which the retaining bar and the support bar are perpendicularly disposed and in which at least one oscillatingly drivable component feeder is inserted,
at least the support bar being lowerable onto the support plate under the action of a spring force, and the component presser element when lowered cooperating with the at least one component feeder,
at least one seam pressing ram being disposed at the bottom of the retaining bar, serving as a seam production tool, and
a laser beam being directed at the support plate and forming a laser light spot there,
wherein
the support plate comprises a translucent work window, which is disposed beneath the seam pressing ram, and the laser beam is directed from beneath at the work window of the support plate, or
the seam pressing ram is designed to be at least partially translucent, and the laser beam is directed from above at the support plate.

2. The seam production machine according to claim 1, wherein the retaining bar is designed as a lifting bar oscillatingly drivable with respect to the longitudinal axis thereof.

3. The seam production machine according to claim 2, wherein the component presser element is designed as a component presser foot.

4. The seam production machine according to claim 1, wherein the retaining bar and the support bar are designed integrally with one another, and form a receiving bar for the seam production tool and the component presser element.

5. The seam production machine according to claim 4, wherein the component presser element and the seam production tool are designed integrally with one another and form the seam pressing ram.

6. The seam production machine according to claim 5, wherein the seam pressing ram is designed as a seam pressing roll.

7. The seam production machine according to claim 1, wherein the seam pressing ram is designed to be at least partially translucent, and the laser beam is directed at the support plate, from above, through the seam pressing ram in the longitudinal direction.

8. The seam production machine according to claim 1, wherein the seam pressing ram, at the end face, has a shaping pressure profile for the joining seam and is exchangeable.

9. The seam production machine according to claim 1, wherein the seam pressing ram completely covers the laser light spot.

10. The seam production machine according to claim 3, wherein the component presser foot has a foot cut-out for the seam pressing ram to pass through, and the foot cut-out and the cross-sectional shape of the seam pressing ram are adapted to one another.

11. The seam production machine according to claim 2, wherein the laser beam is directed at the support plate in a pulsed manner, wherein the pulse duration and the output of the laser beam are dependent on an oscillating frequency of the lifting bar or of the component feeder.

12. The seam production machine according to claim 11, wherein the pulsed laser beam is triggered by the movement of the lifting bar or of the component feeder, wherein the oscillating frequency of the lifting bar or of the component feeder can be set separately from one another.

13. The seam production machine according to claim 1, wherein the lifting bar and the component feeder can be driven synchronously and/or the advancement of the component feeder for each cycle can be set.

14. The seam production machine according to claim 4, wherein in that the laser beam is directed at the support plate in a non-pulsed manner.

15. The seam production machine according to claim 1, wherein the work window and the component feeder are disposed next to one another and move synchronously with one another.
